(19) United States
(12) Patent Application Publication
(10) Pub. No.: US 2026/0102020 A1
(43) Pub. Date: Apr. 16, 2026

(54) INFRARED GRILL WITH PROTECTED INFRARED BURNERS AND A SMOKE INJECTION SYSTEM

(71) Applicant: Joshua Willey, Norton, MA (US)

(72) Inventor: Joshua Willey, Norton, MA (US)

(21) Appl. No.: 18/913,048

(22) Filed: Oct. 11, 2024

(51) Int. Cl. A47J 37/07; A23B 4/052

(52) U.S. Cl. CPC A47J 37/0786; A23B 4/052; A47J 37/0713

(57) ABSTRACT

An infrared grill including mesh layers to prevent the malfunction an infrared burner is disclosed, including a frame having a main body. One or more infrared burners are positioned within the main body and are positioned to direct heat upwards where food is cooked directly above the burner. The main body includes a support surface defining a rim. A first mesh layer positioned on the support surface and a second mesh layer positioned on the first mesh layer. The mesh layers inhibit or prevent fat or oil from dripping onto the one or more infrared burners.

### TECHNICAL FIELD

The embodiments disclosed herein generally relate to grills, and more specifically to grills having an infrared burner and smoke injection systems.

### BACKGROUND

Grills include various tools which are used during the preparation of food. Grills may utilize various fuel sources including gas, charcoal, wood, and electricity to which supply heat to a cooking surface and environment near the source of heat. The housing of the grill is used to support its components as well as provide a cooking environment and surface to transfer heat to the food being prepared.

In particular, some grills which are currently available utilize convection heat. While effective, convection heat does not provide the intensity of heat which is often desired by cooks. Convection heat also requires longer cooking times, resulting in food becoming dried out and undesirable in some cases. This form of heating also requires more fuel. Charcoal grills are effective and allow the user to control the heat by moving the coals to vary the heat in specific regions of the grill. However, the managing heat zones is an acquired skill which can be challenging for some. Further, charcoal grills can be cumbersome and require a sufficient level of technique and preparation throughout the pre-heating and cooking process. Charcoal is also known to be more expensive than other fuel sources.

Infrared burners have become increasingly popular due to their ability to generate high heat. Typically, the infrared burner(s) is positioned to provide heat to only a portion of the cooking surface or environment. This is because infrared burners are known to fail or malfunction due to dripping fat and oil on the infrared burner. In such, the infrared burners are used to sear the food at the beginning or end of the cooking process, while the remaining space of the cooking surface is used throughout the majority of the cooking time. In some examples, the infrared burners are positioned above the food (such as in the case of a Salamander) which protects the infrared burner from the dripping fat or oil.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to an infrared grill including mesh layers to prevent the malfunction an infrared burner, including a frame having a main body. One or more infrared burners are positioned within the main body. The main body includes a support surface defining a rim. A first mesh layer positioned on the support surface and a second mesh layer positioned on the first mesh layer. The mesh layers inhibit or prevent fat or oil from dripping onto the one or more infrared burners.

The embodiments reduce the likelihood of a failure, malfunction, and/or excessive smoke caused by fat or oil dripping onto the heated surface of the infrared burner. The smoke injection system includes a smoke box underneath the grill and includes a manifold. The smoke injection system may include a container with a perforated hinged top wherein wood chips are placed. The manifolds is positioned below the box and the flame heats the bottom of the container, thus heating the wood chips and creating smoke.

The grill includes a frame which supports the various components of the grill and allows the grill to be a free-standing unit. In some embodiments, the grill may be portable. The grill may also be configured as a stationary and standalone grill, a tabletop grill, or a built-in grill system integrated with a countertop. One skilled in the arts will readily understand that the grill may be configured in various sizes, shapes, and be optimized for various use-cases (i.e., restaurant use, commercial use, or at-home use). Sizes of the grill may be modified without deterring from the embodiments provided herein. For example, the grill may be a portable grill used for tailgating, camping, etc. In another example, the grill may be a large commercial grill capable of high-output and high-throughput cooking in a commercial (or restaurant) environment. The grill may also be adapted for home-cooking and may take the form of various at-home grills known in the arts.

The utilization of infrared burners allows for high heat cooking methods to be employed on the grill, such as searing, which is not feasible or not possible using existing grills. While some grills include an infrared burner, they can only be used sparingly as no systems exist which protect the infrared burner from dripping fat or oils. In such, existing grills only include an infrared burner which effects a small portion of the cooking surface or cooking area. The mesh layers allow for infrared burners to be positioned throughout the main body of the grill, thus effecting all, or most, areas of the cooking area. This is accomplished by utilizing mesh layers which protect the infrared burners from the dripping contaminants (e.g., fat, oil, etc.). The contaminants will land on the mesh layer allowing time for the heat turn burn off the contaminants before they contact the infrared burners. In existing infrared burner grills, a ceramic pad is provided on top of the infrared burner, which can become clogged by the contaminants, thus shortening the lifespan of the infrared burner.

In one aspect, wherein the infrared grill includes a smoke injection system. The smoke injection system includes a fuel storage wherein a fuel source is stored. The fuel storage delivers the fuel source to a heating element, the heating element to cause the fuel source to ignite and deliver smoke to a cooking area of the main body. The smoke injection system may include a container with a perforated hinged top wherein wood chips are placed. The manifolds is positioned below the box and the flame heats the bottom of the container, thus heating the wood chips and creating smoke.

In one aspect, the first mesh layer and the second mesh layer are constructed of a stainless steel mesh. The stainless steel mesh may be a 10 mesh T304 stainless steel mesh having a wire diameter of about 0.025-inches.

In one aspect, a gas supply system is provided, including a connector to releasably connect to a vessel storing a gas, and wherein the gas is supplied to the one or more infrared burners via conduit. The gas may be natural gas or a tank containing a gas (e.g., propane). The conduit may include various splitters such that the user can selectively deliver the fuel to one or more of the infrared burners.

In one aspect, the second mesh layer is configured as a grill grate to provide a cooking surface, wherein the one or more infrared burners impart heat onto the grill grate to heat a food being cooked on the infrared grill.

In one aspect, each of the first mesh layer and the second mesh layer define a central portion, wherein the central portion defines the cooking surface.

In one aspect, the first mesh layer includes a first grate frame defining a perimeter of the first mesh layer, wherein the second mesh layer includes a second grate frame defining a perimeter of the second mesh layer, and wherein the first mesh layer and the second mesh layer are removable from the rim to enable cleaning of the first mesh layer and the second mesh layer.

In one aspect, the frame may include a plurality of inverted metal dividers between the infrared burners. The inverted metal dividers support each mesh layer to allow space to be maintained between the infrared burners and the mesh layers. In some examples, the mesh layers are elevated at least 1/2-inch above the top of the infrared burner to reduce the chances of overheating the mesh layers (and in-turn overheating the cooking surface and food cooked thereon).

In one aspect, the first mesh layer and the second mesh layer include a plurality of mesh portions. Each mesh portion may be on only the second mesh layer or on both the first mesh layer and the second mesh layer. The mesh portions reduce the size of the mesh layers, making it easier to remove them or replace them for cleaning, or to change the cooking surface.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the infrared grill and mesh layers, according to some embodiments;

FIG. 2 illustrates a detail view of the gas supply system, according to some embodiments;

FIG. 3 illustrates a detail view of the infrared grill and gas supply system, according to some embodiments;

FIG. 4 illustrates a perspective view of the first and second mesh layers used to protect the infrared burners from oil and fat dripping thereon, according to some embodiments; and

FIG. 5 illustrates a perspective view of the infrared grill and smoke injection system, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate a grill having one or more infrared burners and a smoke injection system. The grill includes at least two layers of protective mesh which protect the infrared burners from fat and oil dripping onto their heated surface. The embodiments reduce the likelihood of a failure, malfunction, and/or excessive smoke caused by fat or oil dripping onto the heated surface of the infrared burner. The smoke injection system includes a smoke box underneath the grill and includes a manifold to deliver heat to the smoke box. This in-turn causes the wood chips within the smoke box to emit smoke.

The grill includes a frame which supports the various components of the grill and allows the grill to be a free-standing unit. In some embodiments, the grill may be portable. The grill may also be configured as a stationary and standalone grill, a tabletop grill, or a built-in grill system integrated with a countertop. One skilled in the arts will readily understand that the grill may be configured in various sizes, shapes, and be optimized for various use-cases (i.e., restaurant use, commercial use, or at-home use). Sizes of the grill may be modified without deterring from the embodiments provided herein. For example, the grill may be a portable grill used for tailgating, camping, etc. In another example, the grill may be a large commercial grill capable of high-output and high-throughput cooking in a commercial (or restaurant) environment. The grill may also be adapted for home-cooking and may take the form of various at-home grills known in the arts.

In some embodiments, the grill is heated by an infrared burner or multiple infrared burners positioned within the frame and main body of the grill. It is to be understood that any reference to an “infrared burner” may be extended to describe a grill having a plurality of infrared burners. The infrared burners are positioned to heat the cooking surface and/or transfer heat to the food being cooked. In some embodiments, a plurality of inverted metal dividers hold the mesh layers above the infrared burners. It may be preferred that the mesh layers are positioned about ½-inch above the top of the infrared burners.

The infrared burners are positioned in a main body of the grill and covered by at least a first layer of mesh and a second layer of mesh, wherein the first layer of mesh is positioned underneath the second layer of mesh. In such, the first layer of mesh is positioned nearmost the infrared burner(s).

In some embodiments, the cooking surface may take various shapes, sizes, configurations, and be constructed of various materials known in the arts. For example, the cooking surface may be a grate. In another example, the cooking surface may be a flat top cooking surface. The cooking surface may also be readily and efficiently interchanged by the user, depending on the particular food being cooked, method of preparation, recipe, desired outcome, etc.

In some embodiments, the second mesh layer may be utilized as the cooking surface.

In some embodiments, each of the first layer of mesh and second layer of mesh is constructed of stainless steel. The mesh may have a 0.025-inch wire diameter to create a layer above the infrared burner(s) which prevents or at least inhibits oil and/or fat from dripping through the mesh and onto the infrared burner(s). In some embodiments, the first and second mesh layers may be stainless steel 10 mesh T304 having a 0.025-inch wire diameter. Other suitable mesh may be utilized to prevent the oil and fat from dripping onto the infrared burners.

In some embodiments, each of the first and second layers of mesh is removably attached to the main body and/or frame of the grill. In such, the user may easily and efficiently remove each of the first and second layers of mesh for cleaning in between uses.

The infrared burner(s) are utilized in the present embodiments are beneficial for providing high heat output to provide a desirable sear to the food being cooked. Utilizing infrared burners, rather than other known heating elements (e.g., gas, wood, charcoal, etc.) is advantageous in that infrared heating elements are known to provide high heat, without imparting undesirable flavors to the food. The infrared burner(s) may include any form of infrared burner known in the arts and may operate by an infrared element positioned between the grill grate and the flame. Gas is used to heat the infrared element which then radiates heat to the food. In some embodiments, a plurality of inverted metal dividers hold the mesh layers above the infrared burners. It may be preferred that the mesh layers are positioned about ½-inch above the top of the infrared burners.

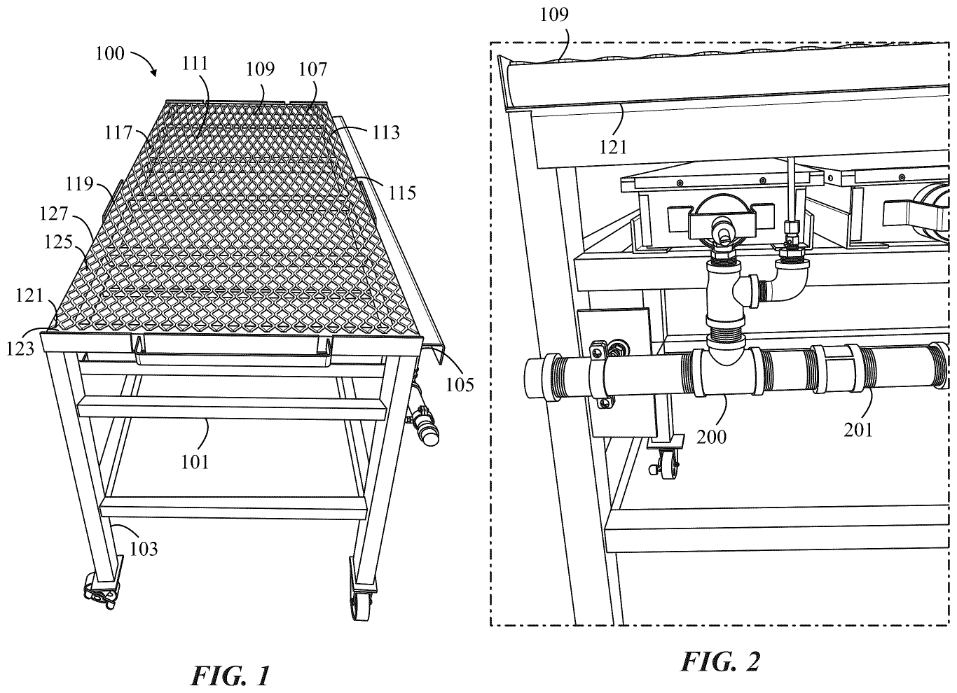

FIG. 1 illustrates a perspective view of the infrared grill 100. The infrared grill includes a frame 101 having a plurality of legs 103 providing support to a main body 105 of the grill 100. The grill 100 may include any number of legs 103 or may be configured as a countertop grill without legs. The main body 105 of the frame 101 includes a top 107 which provides a flat surface to receive the mesh layers 109. Infrared burners 111 are positioned within a cavity 113 of the main body 105. The infrared burners 111 are positioned to provide intense heat to the cooking surface 115. The mesh layers 109 cover at least a portion of, or the entire opening 117 at the top of the main body 105. The mesh layers 109 form a protective cover 119 over the infrared burners 111 and protect from oil and fat dripping thereon.

In some embodiments, the mesh layers 109 are removable from the main body 105. The mesh layers 109 may rest on a support surface 121 which forms a rim 123 around the interior perimeter 125 of the main body 109. In such, the perimeter 127 of the mesh layers 109 is similar, yet slightly less, than the interior perimeter 125 of the main body 105.

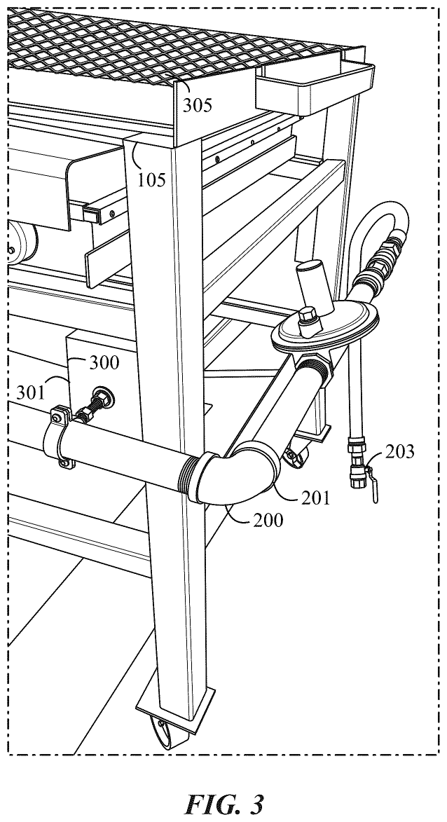

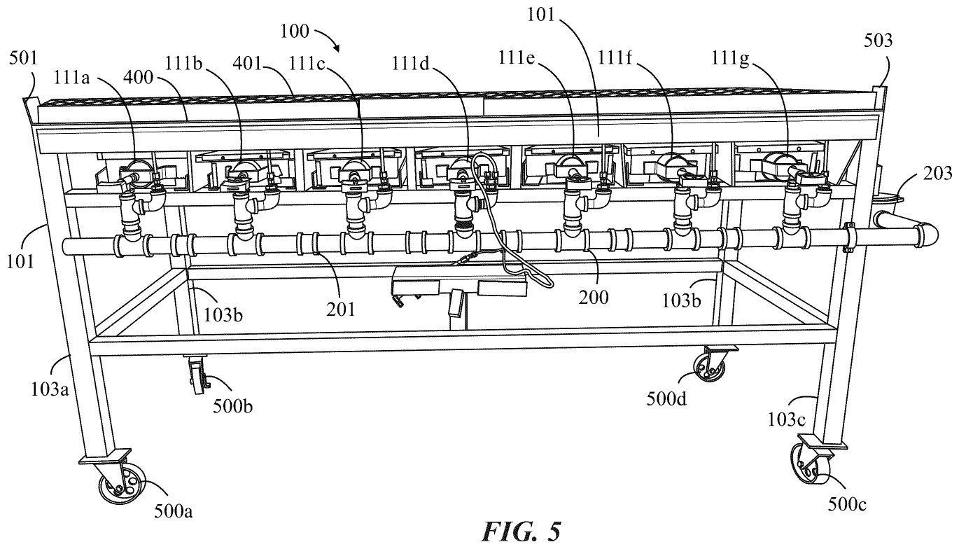

FIG. 2 and FIG. 3 illustrate detail views of the gas supply system 200. The gas supply system includes conduit 201 which delivers gas from a vessel (not shown) such as a propane tank. The vessel is connected using a connector 203 (see FIG. 3 and FIG. 5) which releasably engages with the vessel. Alternatively, the gas may be delivered using natural gas lines, or fed from another remote source (i.e., a large-format gas reservoir/tank). One skilled in the arts will readily understand that the gas supply system 200 may be configured in various configurations, as is known in the arts. The configuration of the gas supply system 200 may be dependent on the size of the grill, the number of infrared burners, the location or environment wherein the grill is placed, etc.

The smoke injection system 300 may include a container 301 to store a fuel source (e.g., wood, wood chips, wood pellets, etc.). The container 301 has a perforated hinged top wherein fuel source are placed. The manifolds is positioned below the box and the flame heats the bottom of the container 301, thus heating the wood chips and creating smoke.

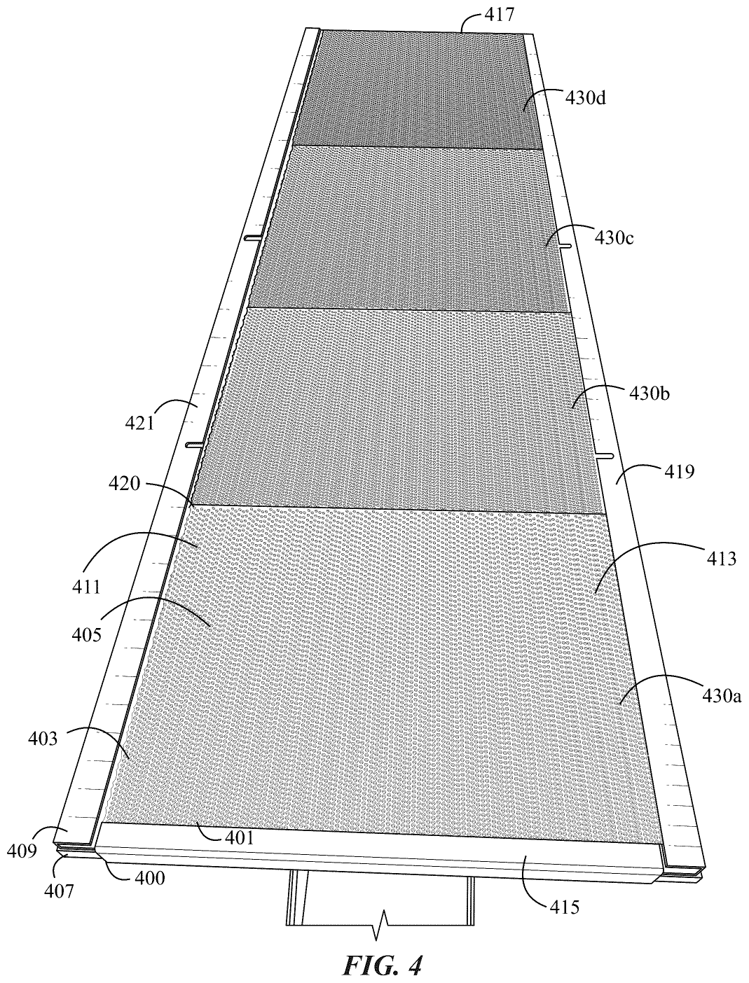

FIG. 4 illustrates the first mesh layer 400 and the second mesh layer 401 which are used to protect the infrared burners from oil and/or fat dripping thereon. Each mesh layer 400,401 may be similarly dimensioned and positioned in a stacked configuration such that the second mesh layer 401 rests on top of the first mesh layer 400. Each mesh layer 400,401 includes a mesh grate 403 constructed of stainless steel mesh (for example 10 mesh T304 having a 0.025-inch wire diameter). The particular mesh utilized is a crucial aspect of protecting the underlying infrared burner(s). However, the specific mesh which is utilized may be modified, so long as the configuration inhibits or prevents the drippage of oil and/or fat onto the infrared burner(s). The mesh grates 403 define a central portion 405 which is bordered by a fist grate frame 407 and a second grate frame 409. The second mesh layer 401 has a top surface 411 which may be used as a cooking surface 413. The top surface 411 may otherwise allow for another cooking surface to be placed thereon (i.e., a flat top, a grill grate, a pan, a pot, a cast iron surface, etc.).

The first grate frame 407 is attached to the first mesh layer 400 and the second grate frame 409 is attached to the second mesh layer 401 and may be referred to collectively as “the grate frame”. Each grate frame 407,409 provides a structural element to the mesh layers 400,401 by providing a rigid frame to maintain the structural integrity of each frate 400,401 such as by maintaining they flat top surfaces. The grate fames 407,409 are positioned within the main body and may include a handle to allow the user to remove them from the grill for cleaning or replacement. Each grate frame 407,409 may be comprised of a left member 415, a right member 417, a front member 419 and a rear member 421 which are connected to form a rectangle or square (or other shape corresponding to the shape of the grill). The components of the grate frame 407,409 may also be integrally connected, according to some embodiments.

In some embodiments, a plurality of inverted metal dividers 420 between the infrared burners. The inverted metal dividers 420 support each mesh layer to allow space to be maintained between the infrared burners and the mesh layers. In some examples, the mesh layers are elevated at least ½-inch above the top of the infrared burner to reduce the chances of overheating the mesh layers (and in-turn overheating the cooking surface and food cooked thereon).

In some embodiments, each of the first mesh layer 400 and the second mesh layer 401 may include a plurality of mesh portions 430a,430b,430c,430d (the example shown in FIG. 4 includes four mesh portions for each mesh layer. It is to be understood that any number of mesh portions may be used depending on the size and configuration of the grill. Further, a single mesh portion may be used which spans the entire cooking surface of the grill.

The mesh may have a 0.025-inch wire diameter to create a layer above the infrared burner(s) which prevents or at least inhibits oil and/or fat from dripping through the mesh and onto the infrared burner(s). In some embodiments, the first and second mesh layers may be stainless steel 10 mesh T304 having a 0.025-inch wire diameter. Other suitable mesh may be utilized to prevent the oil and fat from dripping onto the infrared burners.

FIG. 5 illustrates a perspective view of the infrared grill 100 having the first mesh layer 400 and second mesh layer 401 are positioned on the main body 105 of the frame 101. Legs 103a,103b,103c,103d terminate in wheels 500a,500b,500c,500d which allow the grill 100 to be easily moved to a desired location. The gas supply system 200 may include (in the illustrated embodiment) a main gas supply line 201 which receives gas from a connector 203 and distributes gas to each infrared burner 111a,111b,111c,111d,111e,111f,111g. Handles 501,503 allow for the efficient removal of the mesh layers during cleaning. The handles 501,503 may also be used to move the grill 100.

In some embodiments, the infrared grill includes one or more controls which allow the user to selectively operate each infrared burner. The controls may include at least one igniter and at least one gas flow controller (e.g., a knob) which allows the user to control the heat imparted and delivered by each infrared burner. In some embodiments, each infrared burner is controlled by a dedicated gas flow controller and igniter. In such, the user can turn on or turn off some or all of the infrared burners while cooking. This may be useful in large-format grills which may not need each infrared burner turned on if only a portion of the grill is needed while preparing food.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An infrared grill including mesh layers to prevent the malfunction an infrared burner, the
grill comprising:
a frame including a main body;
one or more infrared burners positioned within the main body, the main body including a support surface defining a rim; and
a first mesh layer and a second mesh layer, the first mesh layer positioned on the support surface and the second mesh layer positioned on the first mesh layer,
wherein the first mesh layer and the second mesh layer inhibit or prevent fat or oil from dripping onto the one or more infrared burners.

2. The infrared grill of claim 1, further comprising a smoke injection system.

3. The infrared grill of claim 2, wherein the smoke injection system includes a container to store the fuel source.

4. The infrared grill of claim 3, wherein the container is heated by a manifold to heat the container and cause the fuel source to smoke.

5. The infrared grill of claim 1, further comprising a gas supply system.

6. The infrared grill of claim 5, wherein the gas supply system includes a connector to releasably connect to a vessel storing a gas, and wherein the gas is supplied to the one or more infrared burners via conduit.

7. The infrared grill of claim 1, wherein the one or more infrared burners impart heat onto the grill grate to heat a food being cooked on the infrared grill.

8. The infrared grill of claim 7, wherein each of the first mesh layer and the second mesh layer define a central portion, wherein the central portion defines the cooking surface.

9. The infrared grill of claim 8, wherein the first mesh layer rests on a plurality of inverted metal dividers.

10. The infrared grill of claim 8, wherein the second mesh layer is supported by the plurality of inverted metal dividers.

11. An infrared grill including mesh layers to prevent the malfunction an infrared burner, the
grill comprising:
a frame including a main body;
one or more infrared burners positioned within the main body, the main body including a support surface defining a rim;
a first mesh layer and a second mesh layer, the first mesh layer positioned on the support surface and the second mesh layer positioned on the first mesh layer;
a smoke injection system including a container to storage a fuel source, wherein the container is heated by a manifold to heat the container and cause the fuel source to emit smoke,
wherein the first mesh layer and the second mesh layer inhibit or prevent fat or oil from dripping onto the one or more infrared burners;

12. The infrared grill of claim 11, wherein the first mesh layer and the second mesh layer are constructed of a stainless steel mesh.

13. The infrared grill of claim 12, wherein the stainless steel mesh is a 10 mesh T304 stainless steel mesh.

14. The infrared grill of claim 13, wherein the 10 mesh T304 stainless steel mesh has a wire diameter of about 0.025-inches.

15. The infrared grill of claim 11, further comprising a gas supply system.

16. The infrared grill of claim 15, wherein the gas supply system includes a connector to releasably connect to a vessel storing a gas, and wherein the gas is supplied to the one or more infrared burners via conduit.

17. The infrared grill of claim 16, wherein the one or more infrared burners impart heat onto the grill grate to heat a food being cooked on the infrared grill.

18. The infrared grill of claim 17, wherein each of the first mesh layer and the second mesh layer define a central portion, wherein the central portion defines the cooking surface.

19. The infrared grill of claim 18, further comprising a plurality of inverted metal dividers to support each mesh layer.

20. The infrared grill of claim 11, wherein the first mesh layer and the second mesh layer include a plurality of mesh portions.
